(19) United States
(12) Patent Application Publication
(10) Pub. No.: US 2024/0335352 A1
(43) Pub. Date: Oct. 10, 2024

(54) DEVICE FOR RELAXING THE TEMPORALIS, MASSETER, OCCIPITAL AND TRAPEZIUS MUSCLES

(71) Applicants: Azadeh Amjadi, Flushing, NY (US); Katerina Dembris, Wantagh, NY (US)

(72) Inventors: Azadeh Amjadi, Flushing, NY (US); Katerina Dembris, Wantagh, NY (US)

(21) Appl. No.: 18/296,109

(22) Filed: Apr. 5, 2023

(51) Int. Cl. A61H 39/04

(52) U.S. Cl. CPC A61H 39/04; A61H 2201/165; A61H 2205/026

(57) ABSTRACT

A wearable mastication muscle relaxer is provided. The wearable mastication muscle relaxer provides headwear with pressure-applying protrusions selectively disposed along its inward-facing surface so that the pressure-applying protrusions align with the temporalis, masseter, medial and lateral pterygoid muscles. The amount of pressure applied by the pressure-applying protrusions is a function of the engagement of adjustable connection points provided by the headwear. Additionally, pressure can be selectively applied on a pressure-point basis through urging each protrusion by way of an associated pressure plate accessible along an outward-facing surface of the headwear.

### BACKGROUND OF THE INVENTION

The present invention relates to treating the muscles of mastication and, more particularly, a head wearable device that aids muscle relaxation for the temporalis, masseter, occipital and the trapezius muscles.

Bruxism is excessive teeth grinding or jaw clenching. It is an oral parafunctional activity in that it is unrelated to normal functions, such as eating or talking. Several symptoms are commonly associated with bruxism, including aching of and tension in the muscles of mastication (the temporalis, masseter, medial and lateral pterygoid muscles), which are paired on either side and work together to move the jaw relative to the skull at the temporomandibular joints.

Current devices for relieving pain associated with clenching and grinding of the teeth are internal devices, and as a result cannot relieve the tension and do not directly engage all the muscles involved in clenching and grinding.

As can be seen, there is a need for a head wearable device that aids muscle relaxation for the temporalis, masseter, occipital and the trapezius muscles (all the muscle groups involved in the clenching and grinding of the teeth), wherein the head wearable device directly and selectively applies pressure to these muscles.

### SUMMARY OF THE INVENTION

In one aspect of the present invention, a device for relaxing a plurality of mastication muscles provide a headwear dimensioned and adapted to overlay the temporalis, masseter, medial and lateral pterygoid muscles of a wearer, wherein an inner surface of the headwear provides one or more pressure points, respectively, adjacent each of the masseter, medial and lateral pterygoid muscles so that each pressure point is configured to selectively apply pressure to its respective muscle by tightening the headwear.

In another aspect of the present invention, the headwear provides a chin strap interconnecting two rear straps; and further providing an adjustable connection point associated with each rear strap, whereby selectively engaging the adjustable connection points tightens or loosens the headwear, which in turn increases or decreases the headwear applies through the plurality of pressure points; and further including two ear loops directly interconnected by the chin strap, wherein each ear loop provides an ear hole adapted for receiving an ear of the wearer, wherein an anterior portion of each ear loop provides the one or more pressure points adjacent to said masseter, medial and lateral pterygoid muscles, wherein the two rear straps are dimensioned and adapted to overlay an occipital-trapezius muscle junction of the wearer; and wherein each rear strap provides one or more pressure points configured to selectively apply pressure to its occipital-trapezius muscle junction by tightening the headwear, and wherein each pressure point has a pressure plate supporting a plurality of protrusions on a first side of the pressure plate, wherein a second side of pressure plate, opposite the first side is disposed to be engaged through an external surface of the headwear, wherein the pressure plate is configured to be engaged through an external surface of the headwear, wherein the headwear does not engage the crown of the head of the wearer, wherein each ear loop radially extends from the ear hole less than in three inches. Conceptually, the headwear is face-wear because of the limited surface of the head it engages, as illustrated in the Figures.

These and other features, aspects and advantages of the present invention will become better understood with reference to the following drawings, description, and claims.

### BRIEF DESCRIPTION OF THE DRAWINGS

FIG. 1 is a front elevation view of an exemplary embodiment of the present invention, shown in use.

FIG. 2 is a side elevation view of an exemplary embodiment of the present invention, shown in use.

FIG. 3 is a rear elevation view of an exemplary embodiment of the present invention, shown in use.

FIG. 4 is a top plan view of an exemplary embodiment of the present invention.

FIG. 5 is a bottom plan view of an exemplary embodiment of the present invention, illustrating the inward-facing surface that directly contacts the user's facial area.

FIG. 6 is a detailed bottom plan view of an exemplary embodiment of the present invention.

FIG. 7 is a front schematic view a muscle group the pressure points contact.

FIG. 8 is a side schematic view a muscle group the pressure points contact.

FIG. 9 is a rear schematic view a muscle group the pressure points contact.

FIG. 10 is a perspective view of an exemplary embodiment of a pressure plate 50 of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a wearable mastication muscle relaxer. The wearable mastication muscle relaxer provides headwear with pressure-applying protrusions selectively disposed along its inward-facing surface so that the pressure-applying protrusions align with the temporalis, masseter, medial and lateral pterygoid muscles. The amount of pressure applied by the pressure-applying protrusions is a function of the engagement of adjustable connection points provided by the headwear. Additionally, pressure can be selectively applied on a pressure-point by pressure-point basis through urging each pressure-point protrusion by way of an associated pressure plate accessible along an outward-facing surface of the headwear.

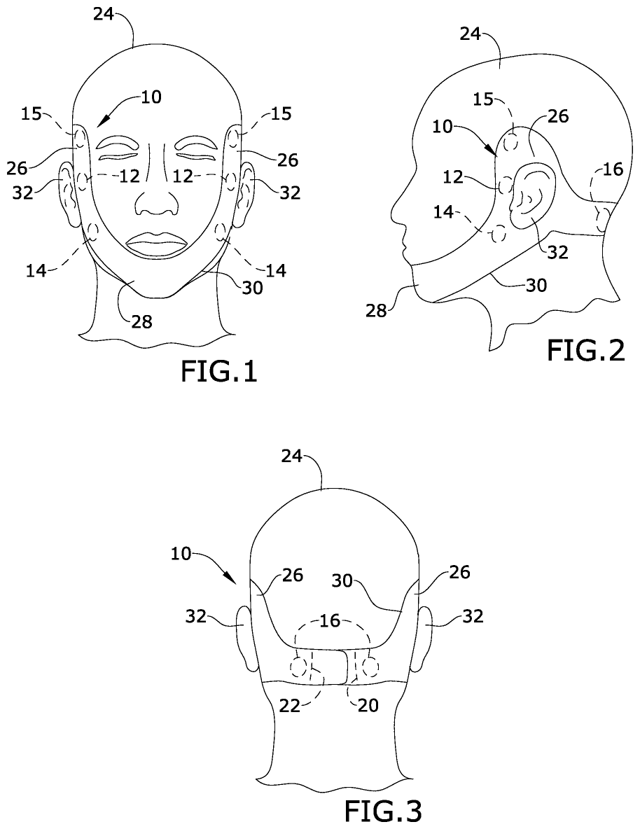

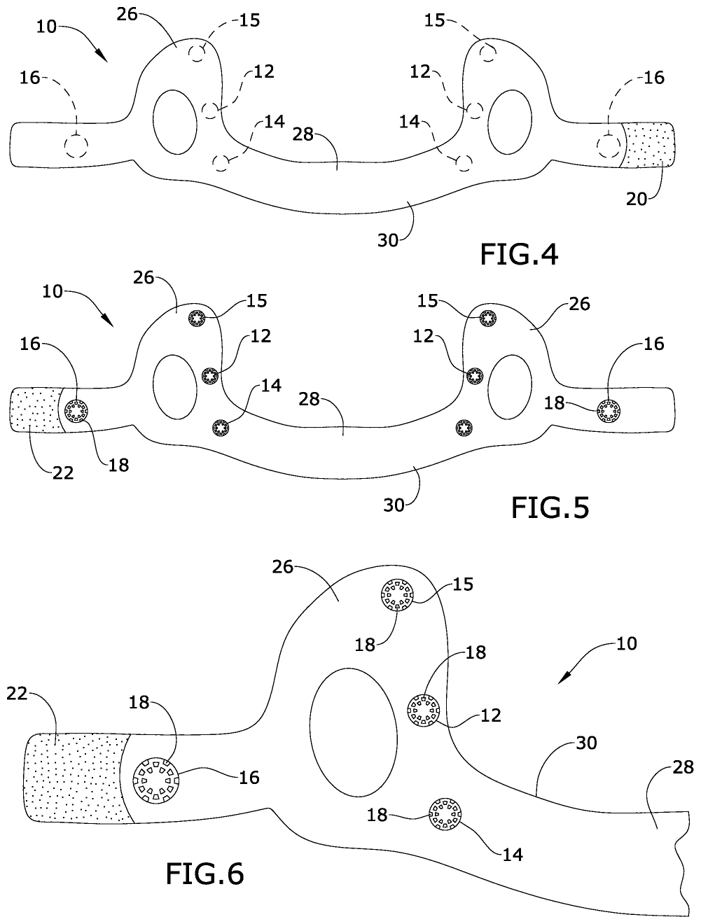

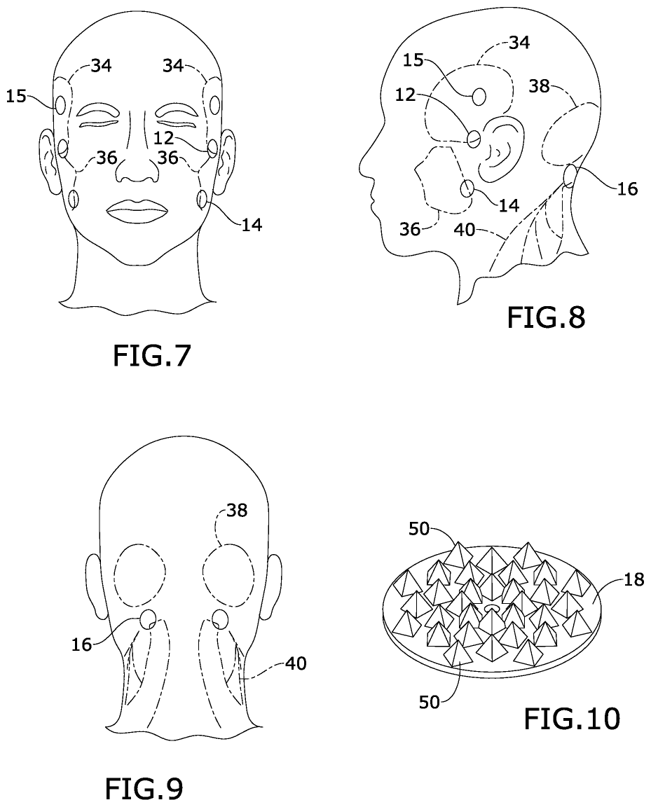

Referring now to FIGS. 1 through 10, the present invention may include headwear 10 embodied in a method for relaxing the muscles of mastication, wherein the headwear provides pressure points 12, 14, 15, and 16 along an inward-facing surface for selectively applying external pressure to the muscles of mastication.

The headwear 10 may include a length of material (or body 30) dimensioned and adapted for wrapping around a head of a user 24, where the body 30 provides one or more adjustable connection points 20 and 22 for adjusting the length of the body 30 to selectively fit different head sizes across the jaw and across the upper neck. The one or more adjustable connection points 20 and 22 also allow the user 24 to selectively tighten and thus decrease or increase the compression across the length of the body 30 that results in applied pressure to the face and neck of a wearer. The one or more adjustable connection points 20 and 22 may include but are not limited to hook and loop fasteners. For instance, the one or more adjustable connection points 20 and 22 could be snaps, a plurality of points of adhesion, or the like. The one or more adjustable connection points 20 and 22 may be at opposing ends of the length and on opposing surfaces, e.g., an inward-facing surface and an opposing outward-facing surface of the body 30.

The headwear 10 provides the pressure points 12, 14, 15, and 16 along specific points along the body 30. Each of the pressure points 12, 14, 15, and 16 may provide a plurality of protrusions or spikes 18 along the inward-facing surface of the body 30 so that the distal ends of the spikes 18 apply pressure against an associated muscle of the plurality of muscles of mastication when the headwear 10 is worn. Each spike 18 may taper to their distal end. The spikes 18 may be plastic acupressure spikes or the like. Along the opposing outward-facing portion of the plurality of spikes (though not necessarily along the outward-facing surface of the body 30, but rather embedded or sewn therein) may be a generally flat or planar “pressure plate” 50 or disc that joins the plurality of spikes 18. The pressure plate 50 outline is shown in dashed lines in the Figures.

The first pressure point 12 may be dimensioned and adapted to apply selectively pressure, through its associated spikes 18, against the zygomatic arch muscles (e.g., the medial and lateral pterygoid muscles).

The second pressure point 14 may be dimensioned and adapted to apply selectively pressure against the masseter muscles.

The third pressure point 15 may be dimensioned and adapted to apply selectively pressure against the temporalis muscles.

The fourth pressure point 16 may be dimensioned and adapted to apply selectively pressure against the occipital and the trapezius muscles.

The body 30 may provide a chin strap 28 interconnecting ear loops 26. Each ear loop 26 provides an ear hole 27 dimensioned and adapted for an ear 32 of the user 24 to be received therein, as illustrated in FIGS. 1-3. The ear loops 26 may interface with the portion of the external ear that bridges to the head, so that when pressure is applied through the ear loops 26—e.g., through the selective engagement of the connection points 20 and 22—this portion acts as a fulcrum relative to the chin strap 28 or otherwise facilitates the application of pressure or at least supports the body 30 during tightening along the headwear 10.

The first, second, and third pressure points 12, 14, and 15 may be disposed along an anterior portion of the ear loop 26. The anterior portion of the ear loop 26 may extend to an elevation at least one inch above the upper portion of the wearer's ear 32. The posterior portion of the ear loop 26 engages a rear portion of the wearer's ear 32 to provide a tensile force along the chin strap 28 engaging the chin of the user 24. This tensile force may be increased or decreased in proportion to the selective engagement of the adjustable connection points 20 and 22. The fourth pressure points 20 may be just inward of the adjustable connection points 20 and 22, whose selective engagement increases or decreases the tensile force in the rear portions 38 of the body 30, and thus the amount of force or pressure the spikes 18 of the fourth pressure point 16 apply against the occipital and the trapezius muscles.

With the pressure points 12, 14, 15, and 16 strategically located along the headwear 10, a user 24 may selectively apply pressure to the plurality of muscles of mastication to provide relief from the clenching and grinding. The pressure may be applied both generally across all the pressure points 12, 14, 15, and 16 through adjustably tightening of the adjustable connection points 20 and 22 and/or specifically by the user 24 selectively depressing the pressure plate 50 associated with one or more of the pressure points 12, 14, 15, and 16 so that their respective spikes 18 apply increased compressive force to an associated muscle of mastication. Thus, a method of providing relief would be the selective combination of this general/uniform and specific/localized/point compressive pressure so that different amounts of compressive stress can be applied to different pressure points 12, 14, 15, or 16.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A device for relaxing a plurality of mastication muscles, the device comprising:
a headwear dimensioned and adapted to overlay the temporalis, masseter, medial and lateral pterygoid muscles of a wearer, wherein an inner surface of the headwear provides one or more pressure points, respectively, adjacent each of the masseter, medial and lateral pterygoid muscles so that each pressure point is configured to selectively apply pressure to its respective muscle by tightening the headwear.

2. The device of claim 1, wherein the headwear provides a chin strap interconnecting two rear straps; and further comprising an adjustable connection point associated with each rear strap, whereby selectively engaging the adjustable connection points tightens the headwear.

3. The device of claim 2, further comprising two ear loops directly interconnected by the chin strap, wherein each ear loop provides an ear hole adapted for receiving an ear of the wearer.

4. The device of claim 3, wherein an anterior portion of each ear loop provides the one or more pressure points adjacent to said masseter, medial and lateral pterygoid muscles.

5. The device of claim 4, wherein the two rear straps are dimensioned and adapted to overlay an occipital-trapezius muscle junction of the wearer; and wherein each rear strap provides one or more pressure points configured to selectively apply pressure to its occipital-trapezius muscle junction by tightening the headwear.

6. The device of claim 5, wherein each pressure point has a pressure plate supporting a plurality of protrusions on a first side of the pressure plate, wherein a second side of pressure plate, opposite the first side is disposed to be engaged through an external surface of the headwear.

7. The device of claim 6, wherein the two adjustable connection points are hook and loop fasteners.

8. The device of claim 7, wherein the headwear does not engage the crown of the head of the wearer.

9. The device of claim 8, wherein the anterior portion of each ear loop extends to an elevation less than three inches above an upper portion of the ear hole.

10. The device of claim 8, wherein each ear loop radially extends from the ear hole less than three inches.
